(19) United States
(12) Patent Application Publication
(10) Pub. No.: US 2004/0197454 A1
(43) Pub. Date: Oct. 7, 2004

(54) Dough intermediate having enhanced textural properties and method of making same

(76) Inventors: Leola K. Henry, Brooklyn Park, MN (US); Mounir M. El Hmamsi, Minneapolis, MN (US); Irina E. Braginsky, Eagan, MN (US); Carol A. Cady, West St. Paul, MN (US)

Correspondence Address: GENERAL MILLS, INC., P.O. BOX 1113, MINNEAPOLIS, MN, 55440, US

(21) Appl. No.: 10/405,439

(22) Filed: Apr. 2, 2003

(51) Int. Cl. A21D 10/00

(52) U.S. Cl. 426/549

(57) ABSTRACT

The present invention is directed to a dough intermediate that upon baking provides a baked product having improved textural characteristics. It has been found that by either limiting the surface contact of the processing equipment with the dough intermediate and the subsequent sealing of the dough surfaces or creating a roughened or abraded dough intermediate through a cutting or severing action, a baked product can be produced having improved crispiness and aesthetic qualities.

### CROSS-REFERENCES TO RELATED APPLICATIONS

None.

### FIELD OF THE INVENTION

The present invention is related to dough intermediates that are useful in creating food products having enhanced textural properties. More specifically, the present invention relates to a dough intermediate and method of producing a dough intermediate that creates a food product more reminiscent of homemade products, through the use of a mechanically induced abrasion that roughens the surface or end edges to expose a portion or area of the dough, resulting in a larger domed shaped product after baking.

### BACKGROUND OF THE INVENTION

The present invention relates to a dough intermediate. A dough intermediate is a product that is intended to undergo at least one further processing step, such as heating, cooking, frying or baking, by the end user prior to consumption. More particularly, the present invention relates to a dough intermediate that is used to create a biscuit, roll, bun or the like and through the present invention yields an end product that has enhanced textural characteristics when compared with that of a conventionally commercially prepared products.

Consumer convenience is a significant consideration in today's marketplace when preparing, distributing and selling food products, both at the retail and wholesale levels. Consumers demand a product that is easy to prepare, yet one that still provides desireable attributes, such as taste, texture and appearance. Merging the needs of the consumer with the realities of the commercial production environment is a challenging and potentially expensive process. That is, often it is necessary to add higher quality ingredients, or increase the amount or types of ingredients to achieve a desired result. This may be due to the stresses that the food products suffer when subjected to commercial manufacturing environments in that rollers, sheeters, and the like can cause food particulates to break off, become crushed and in general have their value diminished in the end product.

The availability of convenient to prepare food items or products that may be ready to eat upon purchase, continue to increasingly permeate our society as the level of on the go consumers increases due to demands of jobs and family life. However, while society continues to move at an ever increasingly rapid rate, there still remains a desire to add a personal or “homey” touch, or to see some personal addition to the product that fulfills the desire of caring either for one's family or for oneself.

Many commercial manufacturers try to replicate the types of products that one would make from scratch in one's home or purchase from a local bakery in order to create a retail package or product, which would have similar characteristics to those products. Unfortunately however, with mass production, unwanted characteristics such as flavors or textures can creep into the product, defeating the goal of the manufacturer. Moreover, due to such manufacturing operations, the ultimate product may not rise or yield the size that one may more regularly find when one prepares products from “scratch.” The result is a disappointing dining experience.

There are a number of products, including dough based products in the marketplace today, which can be taken directly from the freezer case in the retail outlet or from one's home freezer to the oven and even to the microwave oven for final preparation or heating prior to consumption. While the use of microwave ovens has increased over time, the use is primarily directed to heating or thawing products for subsequent consumption. Some of today's freezer-based products are capable of undergoing some level of final cooking or preparation that fulfills the needs of consumers set forth above, that is, adding a cooking, baking or browning step to the meal to be served so that the consumer feels that they have contributed to the process of preparing the meal. However, with the speed and convenience provided by today's ready to bake products, difficulties and other problems have arisen in order for the manufacturer to replicate the desired qualities as if the products had been prepared from scratch.

What is needed therefore, is an easy to prepare product, that is produced from a dough intermediate and which produces a final product that has improved textural characteristics when compared with more conventionally, commercially prepared food products.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

Surprisingly, it has been found that by modifying the manufacturing processes when preparing a dough intermediate, a dough intermediate can be produced which yields a finished baked good product that has enhanced textural properties. More particularly, it has been found that by producing a dough intermediate that is only partially sealed on at least one end edge through contact with the manufacturing or processing apparatus, the dough intermediate is permitted to create a crispier external surface while having a more tender inner surface and generating a larger, sized product.

As such, it has been discovered that through a cutting or severing process, an abrading action occurs on the surface of the dough intermediate, thus exposing surfaces, areas or portions of the dough so as to overcome the effects of sealing of the edges and sides of the dough intermediates that occur during processing.

In one embodiment of the present invention, a dough intermediate for producing a baked food product having enhanced textural characteristics is described and includes at least a dough intermediate prepared from a mixture of at least flour, water and a protein source. The dough intermediate has a generally circumferentially extending side edge and first and second end edges. The generally circumferentially extending side edge is sealed during forming and each of the first and second end edges is not fully sealed due to an abrading or roughening action during forming such that upon baking, a food product is created having improved textural characteristics.

In a still further embodiment of the present invention, a dough intermediate is described and has first and second ends and a circumferentially extending side edge, with each of the first and second ends having a roughened surface texture produced by limited contact with a cutting device and a BSV of at least 2.0.

The dough intermediate of the present invention may also be made in accordance with the following method. The method includes the steps initially, providing a grouping of dry and wet ingredients, then mixing the dry ingredients for a first period of time and subsequently adding the wet ingredients to the dry ingredients and mixing for a second period of time that is distinct from the first period of time to form a dough. The dough is then discharged into a hopper from which it is extruded to create a stream of dough. The dough is then cut or severed in a manner to create a roughened surface and expose unsealed portions of the dough intermediate on an end edge of the dough. The roughened surface providing peaks and points substantially covering the surface or end edges of the dough intermediate. The dough is then baked to produce a domed baking product having enhanced textural characteristics with a BSV of at least 2.0.

In addition to the foregoing method, the present invention contemplates the packaging of the dough intermediates as well as the provision or addition of food particulates on the dough intermediates such as confectionary pieces, fruit pieces, nuts, candy, cheese pieces and combinations and the like.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a prior art baked product produced from a dough intermediate under a conventional commercial process and a front view of a baked product produced from a dough intermediate prepared in connection with the process of the present invention;

FIG. 2 illustrates a top view of a baked product produced from a dough intermediate in connection with the present invention;

FIG. 3 is a flow diagram of a method used in preparation of dough intermediates of the present invention; and

FIG. 4 shows a exemplary schematic of an apparatus used in the preparation of dough intermediates in accordance with the present invention.

### DETAILED DESCRIPTION OF THE INVENTION

The present invention is now illustrated in greater detail by way of the following detailed description, but it should be understood that the present invention is not to be construed as being limited thereto.

It has been found that by manipulating the manufacturing process of a conventional commercial line, that dough intermediates can be produced that will yield a baked product having enhanced textural characteristics.

Without being bound to any particular theory, it is thought that sealing of the surfaces of the dough occurs as a result of the surface or frictional contact between the dough and the processing apparatus. The frictional contact produces heat that causes the exposed surfaces of the dough to seal. Sealing of the dough intermediates results in a lower growth or baked volume of the product produced from the dough intermediate.

The improvement is directed to abrading or roughening the end edges of the dough intermediate through mechanically induced activity that unseals or exposes portions of the dough that had not contacted the processing apparatus thus resulting in a dough intermediate that upon baking produces a fluffier and more tender product.

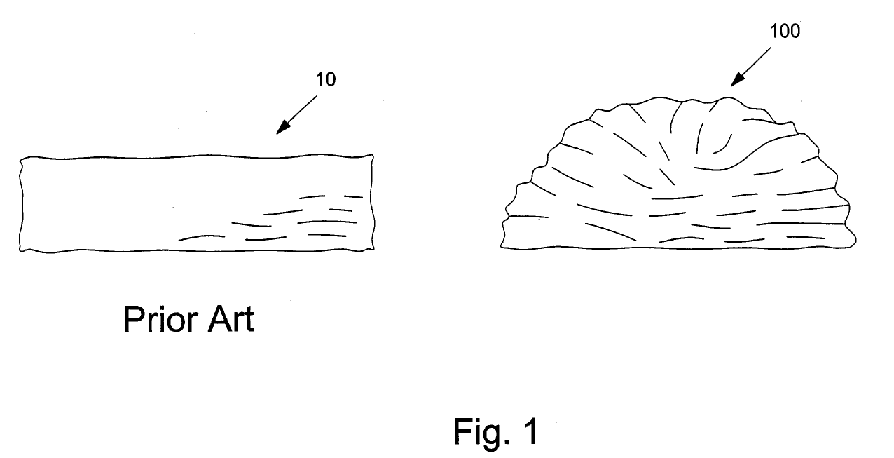

FIG. 1 of the present invention shows a prior art baked product 10 that has been produced from a dough intermediate prepared in connection with a conventional commercial process. FIG. 1 also illustrates a baked product 100 produced from a dough intermediate prepared in connection with the present invention. As can be seen from the comparative illustrations, the baked product of the present invention produces a larger sized finished product as well as one that has improved textural properties.

The food product produced from the dough intermediate 100 has a generally rounded or domed shape that is more reminiscent of homemade products. That is, the baked dough product does not look like it was prepared from mass produced dough intermediates. The dough intermediate 100 of the present invention bakes up lighter and fluffier than conventional products and has an increased number of crispy peaks or points covering the surface of the baked product. It has been found that the baked product prepared from the dough intermediate of the present invention has more than a 30% increase in the number of peaks or points formed due to the rough severing of the dough product from the extruder and the rough surface irregularities imparted to the product from such mechanically induced abrasion.

The following table illustrates the enhanced crispness of the baked product produced from the dough intermediate of the present invention (“drop biscuit”) when compared with a baked product produced from a conventional manufacturing process. Crispness was determined using a texture analyzer in a compression mode. Instrumentally, crispness (or fracturability) is defined as the distance at which the first initial peak is recorded.

[image]

The dome shape of the intermediate also has the advantage of making the surface rougher, thus giving it a more “home style” appearance, that is the dough intermediates are not uniform when viewing a plurality of dough intermediates in a container or after the intermediates have been baked into a final product.

In addition, due to the enhanced appearance of the food product produced from the dough intermediate of the present invention, it has been found that the food product may now be suitable for serving at multiple meals, instead of the traditional biscuit at breakfast. That is, the dough intermediate of the present invention yields a more aesthetically appealing product that can be served in a bread basket such as those that appear for later day meals, like lunch and dinner.

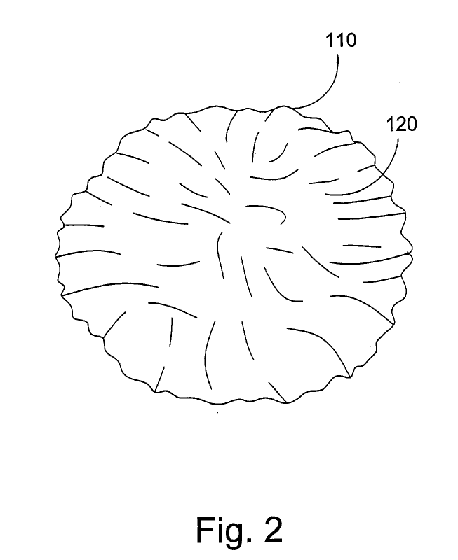

The dough intermediate that produces the baked product 100 of the present invention has a substantially, circumferentially extending side edge 110 (as shown in FIG. 2) and top and bottom or first and second end edges 120 (bottom or second end edge is not illustrated in FIG. 2). It should be inferred that the dough intermediate has a top and bottom surface or end edge.

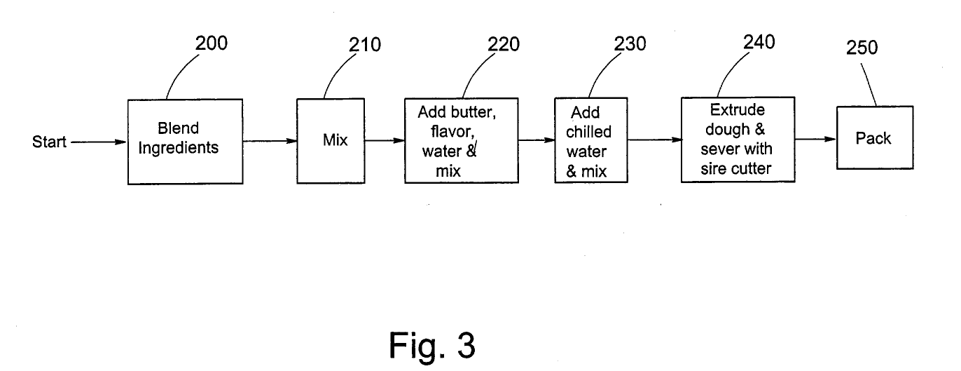

FIG. 3 depicts a schematic of a preferred method used in preparing the dough intermediates of the present invention. Once the process is initiated, the ingredients are blended and added at step 200. Next, the ingredients are mixed at step 210. Butter, flavor and water are added at 220 and again the materials are mixed. Chilled water is added at step 230 and then the material is further mixed to prepare a dough. The dough is then extruded at step 240 and cut through the use of a wire cutter or other cutting means that limits the amount of contact with the surface of the dough. That is, the cutting or severing device physically (through mechanical action) roughens the surface such as by abrading, to unseal or expose previously untouched areas of the dough. This creates peaks and points that cover a substantial portion of the surface of the dough. Finally, once the dough intermediates have been prepared, they are then packed at step 250 for further distribution.

The cutting device of the present invention, preferably a wire cutter, moves at a sufficient speed through the dough in order to sever the stream exiting from the extruder. Speed or cycles of the cutting device is not critical, and depends on the temperature and reaology of the dough. The cutting device selected however, must be able to abrade or roughen the cut end edge of the dough. This can also be done by creating and uneven surface on the blade or wire, such as through plasma coating the material, to further enhance the abrasion of the dough.

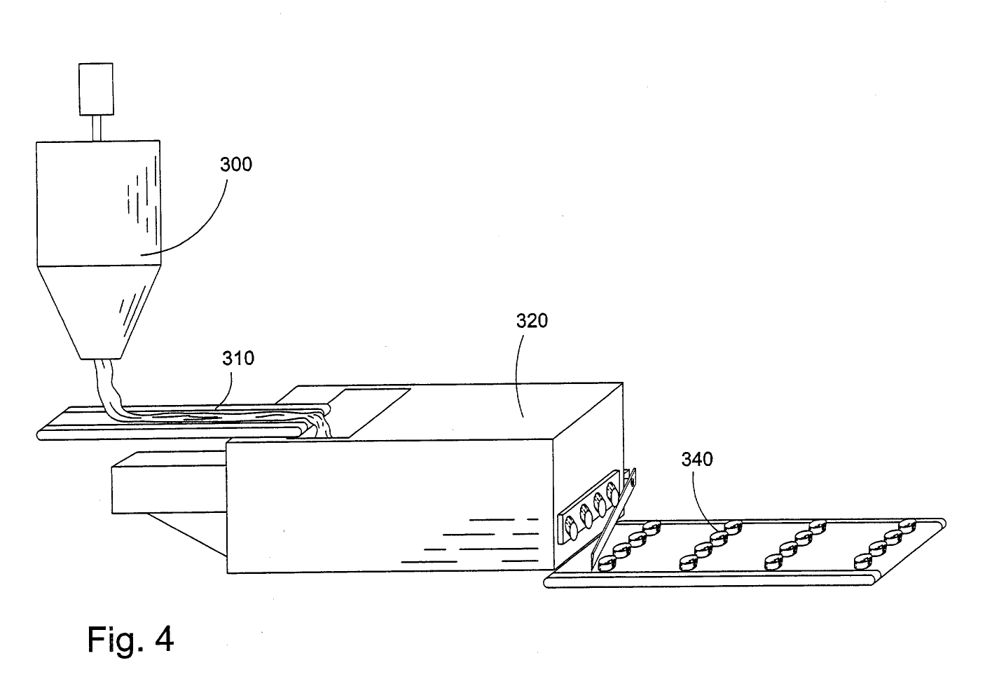

FIG. 4 provides a schematic of an exemplary apparatus used in the production of the dough intermediates of the present invention. The mixing and blending of the ingredients occurs at 300. The ingredients are prepared and blended and then discharged onto a conveyor at 310. The dough is fed into an extruder 320 where a wire cutter or other severing device separates individual dough intermediates 340, and performs the roughening action described above.

The ingredients of an illustrative type of biscuit is shown in the following table.

| | Weight % | Weight % |
|---|---|---|
| Ingredient | (Actual) | (Range) |
| Flour | 43.65 | 30-50 |
| Wheat Protein | 0.20 | .05-0.4 |
| Salt | 1.03 | .03-3.0 |
| Soda | 1.30 | 0.5-2.0 |
| SALP | 1.05 | 0.5-2.0 |
| SAPP | 0.60 | 0.1-1 |
| Sugar | 2.7 | 1-4 |
| Dough | 0.80 | 0.2-2.0 |
| Conditioner | | |
| Butter Flavor | 0.10 | 0.01-2 |
| Caseinate | 0.90 | 0.05-1.5 |
| Soybean Oil | 0.07 | 0.01-2.0 |
| Shortening | 14.00 | 9.0-17.0 |
| Water | 33.60 | 28.45-39.45 |
| Total | 100.00 | |

The ingredients for the formulations were provided as follows: Hydrogenated Vegetable Shortening (Vegetable Shortening; AC Humko Corp.; Memphis, Tenn.); Shortening Chips (Hydrogenated Shortening Chips; Gloden Foods; Louisville, Ky.); Shortening Pellets (Mini Chuck Shortening F327X; Bunge Foods, Bradely, Ill.); Sugar (Crystal Sugar Standard Granulation; United Sugars Corp.; Minneapolis, Minn.); SALP, SAPP (Levn-Lite; Solutia INC. (Monsanto); St. Louis, Mo.); Salt (Culinox 999, Food Grade Salt; Morton International; Chicago, Ill.); Albumin (Dried Egg Whites; Primera Foods; Cameron, Wis.): Caseinate (Ecco 2300 Sodium Caseinate; Erie Foods International; Erie, Ill.); Encapsulated Soda 50% (Bakeshure.RTM 180; Balchem Corp.; Slate Hill, N.Y.); Butter Flavor (Natural Butter WONF# 12331; SKW Biosystems Inc.; Waukesha, Wis.); Flour (Wheat Flour; ADM; North Kansas City, Mo.); Soft Wheat Flour (American Beauty High Ratio cake Flour; ConAgra; Omaha, Nebr.).

A dough suitable for use with the present invention can be prepared by using one-stage mixing to combine the ingredients. One-stage mixing refers to the sequence in which the ingredients are combined. Initially, all dry ingredients (flour, hydrogenated vegetable shortening, shortening chips, sugar, SALP, SAPP, soda, conditioner, etc.) are blended at a low speed ranging from about 20 to 40 rpm for about 30 seconds, prior to adding the liquid ingredients such as, for example, water, butter flavor, propylene glycol, glycerin, etc. The dry ingredients and liquid ingredients are then mixed for about 1.5 to 2 minutes on a low speed, until the ingredients are substantially uniformly integrated. Then the mixture is mixed at a high speed of approximately 40 to 80 rpm for about 3.5 minutes. This mixing sequence is effective to prevent the flour from hydrating and resulting in an overdeveloped dough.

The dough can be mixed in any mixer suitable for combining the ingredients in a manner with low shear and low work input. An example of a suitable mixer includes a Horizontal Bar mixer (champion, Joliet, Ill.). During mixing, the dough is desirably maintained at a temperature that reduces the likelihood that the leavening system will react, maintains the structure of the shortening, and facilitates freezing of the dough. Typically the temperature should be in a range of between about 45° F. (7° C.) and about 70° F. (21° C.), preferably between about 50° F. (10° C.) and about 65° F. (18° C.), and more preferably between about 56° F. (13° C.) and about 62° F. (16° C.). Chilled water or ice chips may be added to the dough in order to retain an optimum temperature of the dough for further processing and to achieve the desired characteristics of the dough.

The mixer may also be equipped with a refrigeration system such as, for example, a jacketed glycol coolant, to maintain the dough within the desirable temperature range in lieu of adding additional moisture to the mixture.

In order to maintain the desirable temperature, in the present exemplary embodiment, water is added to the dry ingredients and should be at a temperature suitable for maintaining the dough at the desirable temperature. Preferably the water is at a temperature of between about 33° F. (1° C.) and 36° F. (2° C.). To bring the water to a temperature suitable for maintaining the dough at the desirable temperature, a portion of the water can be replaced by shaved or crushed ice. The amount and size of the shaved or crushed ice can be determined so that the ice can melt in the water and/or dough during mixing without leaving ice in the mixed and/or deposited dough. If ice remains in the mixed and/or deposited dough, wet spots will appear in the dough, which is undesirable. The size of the shaved or crushed ice can typically be up to about ¼ inch. The portion of water that is replaced by shaved ice can be up to about 20 weight percent of total water.

The dough is mixed at a speed and time that are suitable for maintaining low shear and low work input. For example, when the dry ingredients are blended in a Horizontal Bar mixer, the ingredients can be mixed at a speed in a range of between, for example, about 32 and about 40 rpm. This blending can occur over a time of between, for example, about 28 seconds and about 60 seconds.

When the liquid ingredients are added to the blended dry ingredients in a Horizontal Bar mixer, the ingredients can be mixed, for example, for about 1.5 minutes to about 2 minutes at a speed of, for example, between about 32 rpm and 40 rpm. The speed can then be increased to between, for example, about 64 rpm and about 80 rpm for about 1.5 minutes to about 2 minutes. These times and speeds are merely illustrative and can vary depending on the amount of dough being mixed.

After mixing, the dough should desirably have a temperature of between about 45° F. (7° C.) and about 70° F. (21° C.), preferably between about 50° F. (10° C.) and about 65° F. (18° C.), and more preferably between about 56° F. (13° C.) and about 62° F. (16° C.). Also after mixing, the dough typically has desirable viscoelastic properties, such as a predetermined dough consistency or torque profile. More particularly, the dough typically has a dough consistency ranging from between about 300 B.U. and about 1,200 B.U., preferably between about 400 B.U. and about 1,000 B.U., and more preferably between about 600 B.U. and about 900 B.U. and still more preferably around 700 B.U. to about 800 B.U. according to a Farinograph measurement.

A Farinograph measurement measures a dough's resistance to mixing. To take a Farinograph measurement, a 480 gram sample of the invention can be placed in a jacketed bowl, controlled at a temperature of 60° F. (15° C.), equipped with a sigma blade (C.W. Brabender Instruments, Inc. South Hackensack, N.J.). The sample can then be placed in a Farinograph (C.W. Brabender Instruments, Inc. South Hackensack, N.J.) and measurements can be taken for a time period effective for determining a peak amplitude. The Farinograph can be operated according to the manufacturer's instructions. A peak amplitude can be identified and recorded.

Similarly, the dough can have a torque profile in a range of about 0.3 N•cm and up to greater than about 3 N•cm, preferably between about 0.6 N•cm and about 2.8 N•cm, and more preferably between about 0.9 N•cm and about 2.5 N•cm according to a Haake measurement.

A Haake measurement can be determined using a Haake VT550 viscometer (Haake Co., Paramus, N.J.) with a transducer head of 3 N•cm. The vicsometer can produce a torque profile by carrying out a vane test with a four-bladed vane rotated at a constant rate over a period of time. To carry out a test, a 400 gram sample can be placed in a container, and the sample and container can be equilibrated to about 60° F.+/−2° F. (15° C.+/−2° C.). The container can then be placed in a viscometer and centered underneath a 20 mm by 20 mm vane. The vane can be lowered into the sample until it is at least halfway submerged. The viscometer can then be zeroed, and the measurement can be initiated and run for a period of about 300 seconds. The maximum value on a torque-time curve can be recorded.

After the dough is mixed, it can be transferred to a depositor or hopper for an extruder, and thereafter can be extruded through a die. For example, the dough can be placed into the hopper of a Vemag Extruder (Robert Reiser and company, Inc., Canton, Mass.), which extrudes the dough. An extrusion die plate (as shown in FIG. 4) can be attached to the extruder. The extrusion die plate can have extrusion hole diameters of at least ½ inch, preferably at least 1 inch, and most preferably at least 1½ inches. A standard die can have extrusion holes in a configuration of three sets of holes by six holes across or a variety of other configurations. The die holes are generally circular but can be provided in a variety of shapes including triangular, heart-shaped, oval, square, etc.

As the dough is being extruded, the dough is typically severed from the extruding stream which may be accomplished by any number of cutting devices, including blades, water knifes, ultrasonic cutters, wires, rotary cutters and like. In one exemplary embodiment of the present invention the dough intermediates are separated from the extruded stream and can be cut via a wire into individual single-serve units and dropped onto a sheet of film on a conveyor. It has been found that by using a cutting mechanism that limits the contact or exposure between the dough intermediate and the mechanism, the dough intermediate is not sealed fully sealed on the end edges by the mechanical contact of the cutting apparatus, hence allowing for the dough intermediate to produce a larger, fluffier baked product, in the vertical direction when the dough intermediate is placed on a cooking pan or other appliance. That is, by producing a roughened surface texture, any sealing of the dough that may have occurred during the processing is reduced by the roughening and previously unsealed or “virgin” dough is exposed, enabling a larger, fluffier baked product to be prepared.

As indicated above, it is thought that sealing of the surfaces of the dough occurs as a result of the surface or frictional contact between the dough and the processing apparatus. The frictional contact produces heat that causes the exposed surfaces of the dough to seal. Sealing of the dough intermediates results in a lower growth or baked volume of the product produced from the dough intermediate.

That is, use of the cutting device and the contact that the cutting device has with the end edge of the dough being extruded, exposes portions or surface areas of the dough that have not been exposed to the processing equipment, in effect unsealing the dough ends so that the dough intermediate may rise higher during baking, that is, exposing virgin areas of the dough. The term “virgin” as used herein refers to portions of the dough that have not previously encountered the hopper, extruder or other processing equipment, except for perhaps the mixer.

The die of the extruder as well as the extruder itself (as shown in FIG. 4) have increased contact with the dough as it is being extruded along the side edges of the dough. This has been found to have a sealing effect on the sides of the dough intermediate such that upon baking the sides of the dough intermediate do not expand significantly outward. Preferably, the die used in preparation of the dough intermediate of the present invention is substantially circular or oval which produces dough intermediates ranging from generally round to oval in shape.

The following graph illustrates the resulting increase in the height of the baked product from the dough intermediate of the present invention (“drop biscuit”) when compared with a baked product produced from a dough “puck” prepared in a conventional manner.

[image]

As can be seen from the chart, the baked product prepared from the dough intermediate of the present invention yields about a 15% increase in height of the baked product, resulting in a fluffier, flakier product.

The individual dough intermediates range in size from about 0.5 ounces to about 8 ounces, preferably from about 2 ounces to about 6 ounces, and most preferably from about 3.5 ounces to about 5.5 ounces. The dough on a sheet of film can then be conveyed into and through a freezer. The freezer set temperature and dwell time can be set to achieve a maximum exit temperature of about 0° F. (−17° C.) to about 15° F. (−9° C.), preferably about 10° F. (−12° C.). The dough can be frozen at a temperature of between about −10° F. (−23° C.) and about −15° F. (−9° C.). The dough is preferably frozen as quickly and completely as possible to preserve freshness.

Thereafter, the dough can be packaged in a variety of packaging configurations. For example, the frozen individual single-serve units can be placed in a lined cardboard container in a configuration of six layers of the units with thirty individual units per layer, or in a portioned controlled configuration of 2 or 4 dough intermediates in a sleeve or envelope which may be enclosed in an outer container that is capable of holding several of such sleeves.

The individual frozen single-serve units of dough can then be placed in a finish/storage freezer until ready for use. The end user can then place the individual single-serve units of dough on a baking sheet in an oven without an intermediate thawing or proofing step, and baked to obtain a desirably consumable product having a Baked Specific Volume (BSV) of at least 2.0 cc/g but less than 2.5.

In order to prepare the shaped dough intermediates of the present invention, a number of controls are used to achieve the desired dough intermediate product. For example, but running a take away conveyor at a relatively slow speed, the dough after being severed from the extruder can drop onto the conveyor and are less likely to spread or touch subsequent dough intermediates. Likewise, raising or lowering the level of the conveyor belt also controls the amount of spread the dough intermediate is subjected to. That is, the conveyor belt is raised up during a cutting or severing cycle to be near or adjacent to the extruded material so as to receive the material without the material falling a significant distance.

This invention will be further characterized by the following example. The example is not meant to limit the scope of the invention, which has been fully set forth in the foregoing description. Variations within the scope of the invention will be apparent to those skilled in the art.

The following example depicts a non-limiting illustration of the various attributes of the invention when prepared.

To prepare a dough in accordance with the present invention, one-stage mixing in a Horizontal Bar mixer equipped with a jacketed glycol coolant combines the ingredients. For each dough formulation, all of the dry ingredients (flour, hydrogenated vegetable shortening, shortening chips and/or pellets, sugar, SALP, citric acid, salt, corn-syrup solids, albumin, caseinate, buttermilk solids, dextrose, encapsulated soda, cheese powder, and cheese pieces) were blended at a speed of between about 32 rpm and about 40 rpm for about 30 seconds.

The liquid ingredients (water, butter flavor, propylene glycol, glycerin, and yellow no. 5) were then added. The added water, which contained shaved ice in an amount of about 10 weight percent of total water, was at a temperature of between about 33° F. (1° C.) and about 36° F. (2° C.). The liquid and dry ingredients were then mixed from about 1.5 to about 2 minutes at a speed of between about 32 rpm and 40 rpm. The speed was then increased to between about 64 rpm and about 80 rpm for about 1.5 minutes.

After mixing, the dough was at a temperature of between about 56° F. (13° C.) and about 62° F. (16° C.).

The dough was transferred to the hopper of a Vemag extruder, which vertically extruded the dough through a die into 4.5 ounce individual single-serve units onto a film sheet on a conveyor.

The dough was then frozen at a temperature of between about −10° F. (−23° C.) and about −15° F. (−26° C.) and the final temperature of the dough was about 10° F. (−12° C.).

The 4.5 ounce individual single-serve units of dough were then packaged and shipped to a customer or retail outlet.

Thereafter the customer places the single-serve units on a baking sheet and places it in an oven without an intermediate proofing or thawing step.

The dough intermediate of the present invention may also be provided with pieces of fruit, confectionary bits, cheese, nuts or other flavor or texture imparting elements that may expand on the aesthetic appeal of the product. In addition, it has been found that the roughened end edge surface texture is more accommodating to receiving such ancillary elements than conventional dough intermediates. That is, with conventionally prepared dough products, the ancillary elements had a tendency to fall off as there are not ridges, peaks or valleys to hold the elements in place.

It will thus be seen according to the present invention a highly advantageous dough intermediate and method of producing the enhanced baked product has been provided. While the invention has been described in connection with what is presently considered to be the most practical and preferred embodiment, it will be apparent to those of ordinary skill in the art that the invention is not to be limited to the disclosed embodiment, that many modifications and equivalent arrangements may be made thereof within the scope of the invention, which scope is to be accorded the broadest interpretation of the appended claims so as to encompass all equivalent structures and products.

1. A dough intermediate for producing a baked food product having enhanced textural characteristics, comprising;
a dough intermediate prepared from a mixture of at least flour, water and a protein source, said dough intermediate having a generally circumferentially extending side edge and first and second end edges and a BSV of at least 2.0; and
wherein said generally circumferentially extending side edge is sealed during forming and each of said first and second end edges is not fully sealed due to an abrading action during forming such that upon baking a food product is created having improved textural characteristics.

2. A dough intermediate as recited in claim 1, wherein said generally substantially circumferentially extending side edges are sealed by extrusion through a die.

3. A dough intermediate as recited in claim 1, wherein said first and second end edges are partially abraded through contact with a forming apparatus.

4. A dough intermediate as recited in claim 3, wherein said first and second end edges are partially abraded by a cutting element in the forming apparatus.

5. A dough intermediate as recited in claim 1, wherein one of said first and second end edges produces a dome shape upon baking.

6. A dough intermediate as recited in claim 1, wherein said substantially circumferentially side edge is generally round.

7. A dough intermediate as recited in claim 1, wherein said substantially circumferentially side edge is generally oval.

8. A dough intermediate as recited in claim 1, wherein the dough intermediate has a B.U. ranging from about 300 to about 1200.

9. A dough intermediate as recited in claim 1, wherein the dough intermediate is suitable for preparing rolls, biscuits, buns and combinations thereof.

10. A dough intermediate having first and second ends and a circumferentially extending side edge, each of said first and second ends having a roughened surface texture produced by limited contact with a cutting device and a BSV of at least 2.0.

11. A dough intermediate as recited in claim 10, wherein the dough intermediate has a B.U. ranging from about 300 to about 1200.

12. A dough intermediate as recited in claim 10, wherein each of said first and second ends are partially sealed by a processing apparatus and said circumferentially extending side edge is substantially sealed.

13. A dough intermediate as recited in claim 1, wherein the dough intermediate is suitable for preparing rolls, biscuits, buns and combinations thereof.

14. A method of producing a dough intermediate having enhanced textural characteristics, comprising the steps of;
providing a grouping of dry and wet ingredients;
mixing the dry ingredients for a first period of time;
adding the wet ingredients to the dry ingredients and mixing for a second period of time distinct from said first period of time to form a dough;
discharging said dough into an extruder;
extruding said dough to create a stream of extrudate;
severing said dough from the stream in a manner to create a roughened surface and expose unsealed portions of the dough intermediate on at least an end edge of said dough, said roughened surface providing peaks and points substantially covering the roughened surface; and
baking said dough intermediate to produce a domed baking product having enhanced textural characteristics with a BSV of at least 2.0.

15. A method of producing a dough intermediate as recited in claim 14, wherein the dough intermediate has a B.U. ranging from about 300 to about 1200.

16. A method of producing a dough intermediate as recited in claim 14, including a further step of packing the dough intermediates into containers after the step of cutting the dough.

17. A method of producing a dough intermediate as recited in claim 14, including a further step of adding particulates selected from a group including confectionary pieces, fruit pieces, nuts, candy, cheese pieces and combinations thereof.

18. A method of producing a dough intermediate as recited in claim 14, including a further step of chilling the dough after the step of adding the wet ingredients.

19. A method of producing a dough intermediate as recited in claim 14, wherein the dough intermediate is suitable for preparing rolls, biscuits, buns and combinations thereof.
